(19) United States
(12) Patent Application Publication
(10) Pub. No.: US 2019/0257655 A1
(43) Pub. Date: Aug. 22, 2019

(54) COMPOSITE SENSOR

(71) Applicant: Panasonic Intellectual Property Management Co., Ltd., Osaka (JP)

(72) Inventor: KAZUMA TSUKAMOTO, Fukui (JP)

(21) Appl. No.: 16/084,012

(22) PCT Filed: Mar. 16, 2017
(86) PCT No.: PCT/JP2017/010570

§ 371 Date: Sep. 11, 2018

(30) Foreign Application Priority Data
Mar. 24, 2016 (JP) 2016-059372
Sep. 5, 2016 (JP) 2016-172420

(51) Int. Cl. G01C 19/5776; G01P 15/08; G01P 15/12; G01P 21/00; G01P 15/18

(52) U.S. Cl. CPC G01C 19/5776; G01P 15/0802; G01P 15/18; G01P 21/00; G01P 15/122

(57) ABSTRACT

A composite sensor includes an angular-velocity detection element that outputs a sense signal according to an angular velocity applied thereto, a sense circuit that outputs, based on the sense signal, an angular velocity signal indicating the angular velocity, an acceleration detection element that outputs an signal according to acceleration applied thereto, an acceleration detection circuit that outputs, based on the signal output from the acceleration detection element, an acceleration signal indicating the acceleration, a bandpass filter to which the acceleration signal is input, an amplitude determination circuit that determines, based on an amplitude of a first signal output from the bandpass filter, whether or not the angular velocity signal is invalid, and a timing control circuit that outputs a sensor output signal including the angular velocity signal and the acceleration signal.

### TECHNICAL FIELD

The present invention relates to a composite sensor for detecting angular velocity and acceleration.

### BACKGROUND ART

FIG. 9 is a circuit block diagram of conventional angular velocity sensor 500.

Drive electrodes 2 made of gold are provided on four side surfaces of angular-velocity detection element 1 made of a crystal having a tuning-fork shape. Monitor electrodes 3 made of gold are provided on front and back surfaces of angular-velocity detection element 1. GND electrode 4 made of gold is provided on inner side surfaces of angular-velocity detection element 1. Sense electrodes 5 and 6 made of gold are provided on outer side surfaces of angular-velocity detection element 1. Drive circuit 7 inputs a drive signal to drive electrode 2 of angular-velocity detection element 1 while electric charge of monitor electrode 3 of angular-velocity detection element 1 is input thereto. Sense circuit 8 receives electric charge generated on sense electrode 5 of angular-velocity detection element 1 due to Coriolis force and electric charge generated on sense electrode 6 due to Coriolis force, and then, outputs an angular velocity signal.

Adder 9 adds correction data to the angular velocity signal from sense circuit 8. Temperature sensor 10 is provided around angular-velocity detection element 1. A/D convertor 11 converts an analog output signal of temperature sensor 10 into a digital output signal. Memory 12 implemented by an EEPROM stores data for correcting an error of the output signal from sense circuit 8.

An operation of angular velocity sensor 500 will be described below.

An alternating-current voltage applied to drive electrode 2 of angular-velocity detection element 1 causes angular-velocity detection element 1 to resonate, thereby generating an electric charge on monitor electrode 3 of angular-velocity detection element 1. The electric charge generated on monitor electrode 3 is input to drive electrode 2 via drive circuit 7, and vibration of angular-velocity detection element 1 is adjusted to have a fixed amplitude.

While angular-velocity detection element 1 bends and vibrates at speed v in a vibration direction, if angular-velocity detection element 1 rotates about a central axis extending in a longitudinal direction of angular-velocity detection element 1 at angular velocity co, accordingly producing Coriolis force F expressed as F=2mV×ω in angular-velocity detection element 1. Coriolis force F generates electric charges on sense electrodes 5 and 6. According to the electric charges, an output signal is output to the outside through sense circuit 8 as an angular velocity signal.

PTL 1 is known as a prior art documents about angular velocity sensor 500.

### CITATION LIST

### Patent Literature

PTL 1: Japanese Patent Laid-Open Publication No. 2008-170294

### SUMMARY

A composite sensor includes an angular-velocity detection element that outputs a sense signal according to an angular velocity applied thereto, a sense circuit that outputs, based on the sense signal, an angular velocity signal indicating the angular velocity, an acceleration detection element that outputs an signal according to acceleration applied thereto, an acceleration detection circuit that outputs, based on the signal output from the acceleration detection element, an acceleration signal indicating the acceleration, a bandpass filter to which the acceleration signal is input, an amplitude determination circuit that determines, based on an amplitude of a first signal output from the bandpass filter, whether or not the angular velocity signal is invalid, and a timing control circuit that outputs a sensor output signal including the angular velocity signal and the acceleration signal.

### BRIEF DESCRIPTION OF DRAWINGS

FIG. 1 is a circuit block diagram of a composite sensor in accordance with an exemplary embodiment.

FIG. 2A is a circuit diagram of an angular velocity sensor section of the composite sensor in the exemplary embodiment.

FIG. 2B is a view showing an operation of the angular velocity sensor section in the exemplary embodiment.

FIG. 3 is a top view of an acceleration detection element of an acceleration sensor section of the composite sensor in the exemplary embodiment.

FIG. 4 is a top view of the acceleration detection element in the exemplary embodiment.

FIG. 5A is a view showing a bridge circuit for detecting acceleration of the acceleration sensor section in the exemplary embodiment.

FIG. 5B is a view showing a bridge circuit for detecting acceleration of the acceleration sensor section in the exemplary embodiment.

FIG. 6 is a circuit block diagram of the acceleration sensor section in the exemplary embodiment.

FIG. 7A is a view showing a sensor output signal output from the composite sensor in the exemplary embodiment.

FIG. 7B is a view showing the sensor output signal output from the composite sensor in the exemplary embodiment.

FIG. 7C is a view showing the sensor output signal output from the composite sensor in the exemplary embodiment.

FIG. 7D is a view showing another sensor output signal output from the composite sensor in the exemplary embodiment.

FIG. 8A is a circuit block diagram of another composite sensor for detection in the exemplary embodiment.

FIG. 8B is a circuit block diagram of still another composite sensor for detection in the exemplary embodiment.

FIG. 9 is a circuit block diagram of the conventional angular velocity sensor.

### DETAILED DESCRIPTION OF PREFERRED EMBODIMENT

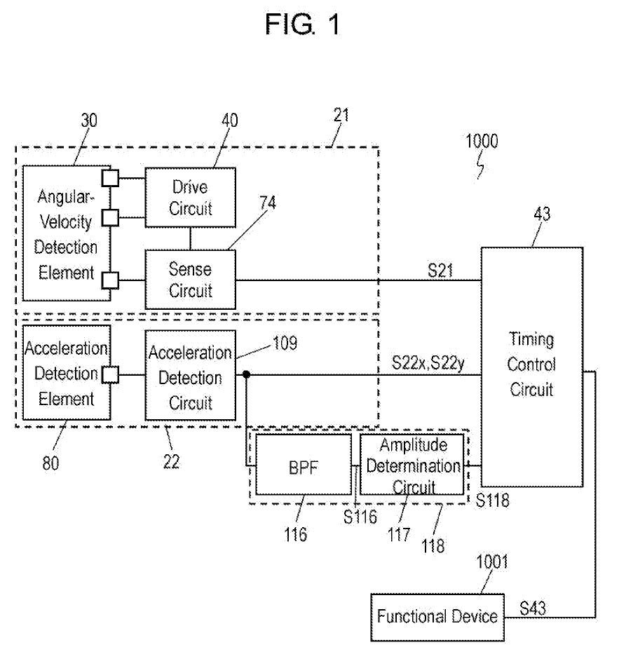

FIG. 1 is a block diagram of composite sensor 1000 in an exemplary embodiment. Composite sensor 1000 includes angular velocity sensor section 21 that detects angular velocity and acceleration sensor section 22 that detects acceleration.

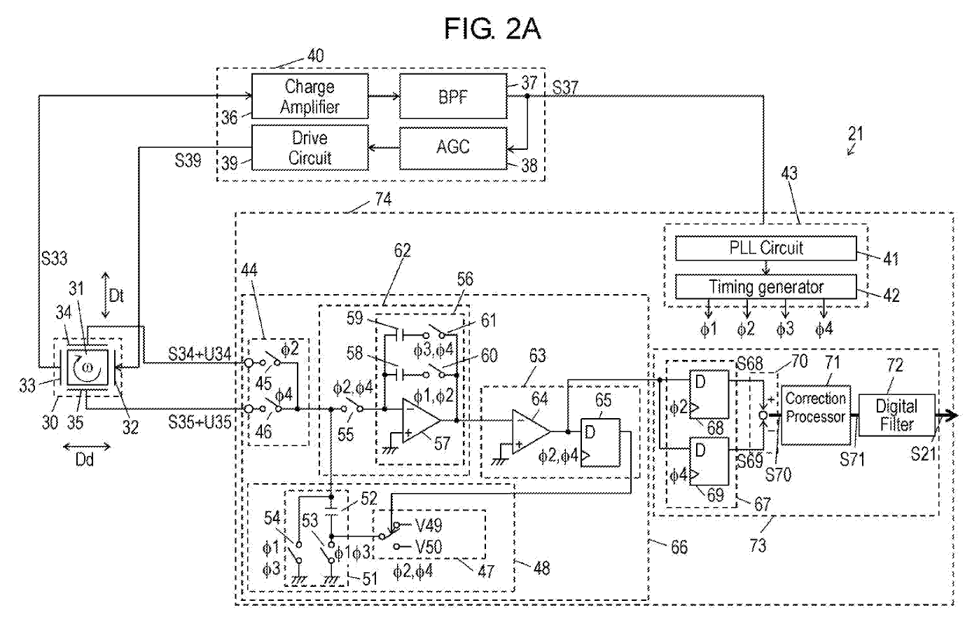

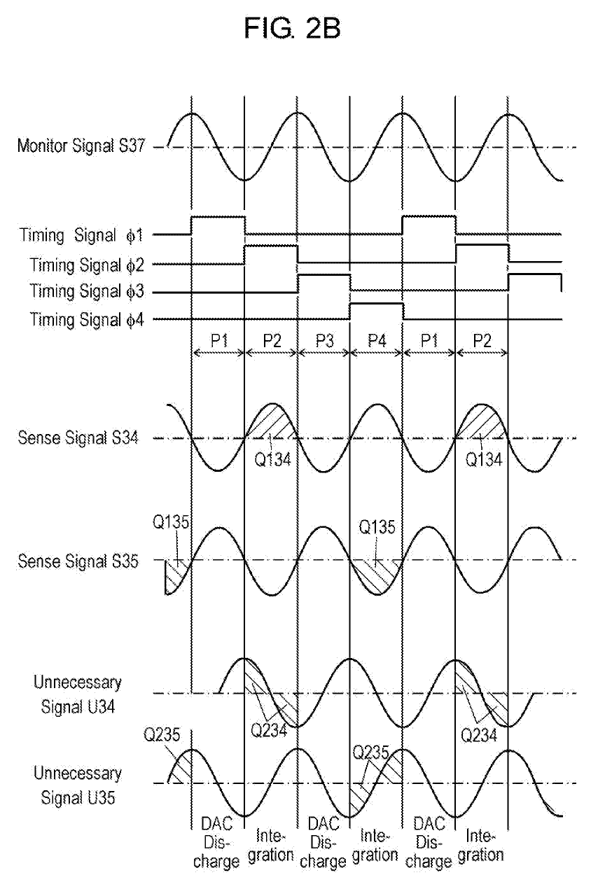

FIG. 2A is a circuit diagram of angular velocity sensor section 21. FIG. 2B shows signals of parts of angular velocity sensor section 21 under an operation of angular velocity sensor section 21. Angular-velocity detection element 30 includes vibration body 31, drive electrode 32 provided on vibration body 31, monitor electrode 33 provided on vibration body 31, and sense electrodes 34 and 35 provided on vibration body 31. Drive electrode 32 includes a piezoelectric body that causes vibration body 31 to vibrate. Monitor electrode 33 includes a piezoelectric body that generates an electric charge according to the vibration of vibration body 31. Sense electrodes 34 and 35 include piezoelectric bodies that generate electric charges having polarities opposite to each other when angular velocity is applied to vibration body 31 of angular-velocity detection element 30. Charge amplifier 36 amplifies the electric charge output from monitor electrode 33 at a predetermined gain, converts the amplified charge into a voltage signal, and outputs the voltage signal. Bandpass filter 37 removes a noise component of the signal output from charge amplifier 36, and outputs the signal as a monitor signal. AGC circuit 38 has a half-wave rectification smoothing circuit. The monitor signal output from bandpass filter 37 is half-wave rectified and smoothed to generate a direct-current (DC) signal. The monitor signal output from bandpass filter 37 is amplified or attenuated based on the DC signal, and then, is output. Drive circuit 39 outputs drive signal S39 to drive electrode 32 of angular-velocity detection element 30 based on monitor signal S37 output from AGC circuit 38. Charge amplifier 36, bandpass filter 37, AGC circuit 38, and drive circuit 39 constitute drive circuit 40.

PLL (Phase Locked Loop) circuit 41 multiplies the frequency of the monitor signal output from bandpass filter 37 of drive circuit 40 and integrates a phase noise over time, thereby reducing the phase noise, and then, outputs the signal as a frequency-multiplied monitor signal. Based on the frequency-multiplied monitor signal output from PLL circuit 41, timing generator 42 generates and outputs timing signals ϕ1, ϕ2, ϕ3, and ϕ4. Each of timing signals ϕ1, ϕ2, ϕ3, and ϕ4 alternately repeats a high level, which serves as an active level, and a low level, which serves as a non-active level, at a period twice the period of the monitor signal. Periods P1, P2, P3, and

P4 are repeated sequentially in this order at a period twice the period of the monitor signal. Timing signals ϕ1, ϕ2, ϕ3, and ϕ4 are turned into the high level exclusively in this order during periods P1, P2, P3, and P4, respectively. Specifically, timing signal ϕ1 has the high level during period P1, and has the low level during periods P2 to P4. Timing signal ϕ2 has the high level during period P2, and has the low level during periods P1, P3, and P4. Timing signal ϕ3 has the high level during period P3, and has the low level during periods P1, P2, and P4. Timing signal ϕ4 has the high level during period P4, and has the low level during periods P1 to P3. In other words, during period P1, timing signal ϕ1 has the high level, and timing signals ϕ2, ϕ3, and ϕ4 have the low level. During period P2, timing signal ϕ2 has the high level, and timing signals ϕ1, ϕ3, and ϕ4 have the low level. During period P3, timing signal ϕ3 has the high level, and timing signals ϕ1, ϕ2, and ϕ4 have the low level. During period P4, timing signal ϕ4 has the high level, and timing signals ϕ1, ϕ2, and ϕ3 have the low level.

Angular velocity sensor section 21 includes analog switches (SW) activated in response to timing signals ϕ1 to ϕ4. Each of the analog switch activated in response to the timing signal is turned on when the timing signal has the high level (an active level), and is turned off when the timing signal has the low level (non-active level).

PLL circuit 41 and timing generator 42 constitute timing control circuit 43. Input switching unit 44 is constituted by analog switches (SW) 45 and 46. Analog switch 45 is connected to sense electrode 34 of angular-velocity detection element 30, and operates in response to timing signal ϕ2, i.e., is turned on when timing signal ϕ2 has the high-level, and is turned off when timing signal ϕ2 has the low level. Analog switch 46 is connected to sense electrode 35, and operates in response to timing signal ϕ4, i.e., is turned on when timing signal ϕ4 has the high-level, and is turned off when timing signal ϕ4 has the low level. Input switching unit 44 switches the signals input from sense electrodes 34 and 35 in response to timing signals ϕ2 and ϕ4, and outputs the switched signal. DA switching unit 47 switches reference voltages V49 and V50 in response to a predetermined signal, and outputs the switched voltage. Specifically, DA switching unit 47 outputs reference voltage V49 when timing signal ϕ2 has the high level, and outputs reference voltage V50 when timing signal ϕ4 has the high level. When both timing signals ϕ2 and ϕ4 have the low level, DA switching unit 47 outputs neither reference voltage V49 nor reference voltage V50. DA output unit 51 includes capacitor 52 to which the voltage output from DA switching unit 47 is input, and analog switches 53 and 54 connected to both ends of capacitor 52. Analog switch 53 operates in response to timing signal ϕ1, i.e., is turned on so as to discharge electric charge of capacitor 52 when timing signal ϕ1 has the high level, and is turned off when timing signal ϕ1 has the low level. Analog switch 54 operates in response to timing signal ϕ3, i.e., is turned on so as to discharge electric charge of capacitor 52 when timing signal ϕ3 has the high level, and is turned off when timing signal ϕ3 has the low level. DA switching unit 47 and DA output unit 51 constitute DA conversion unit 48. DA conversion unit 48 discharges the electric charge of capacitor 52 when one of timing signals ϕ1 and ϕ3 has the high level. When one of timing signals ϕ2 and ϕ4 has the high level, DA conversion unit 48 outputs or inputs an electric charge according to the reference voltage output from DA switching unit 47. The analog switch which operates in response to any one of the timing signals of angular velocity sensor section 21 is turned on when the timing signal has the high level (the active level), and is turned off when the timing signal has the low level (the non-active level).

Analog switch 55 outputs an output of input switching unit 44 and DA conversion unit 48 when one of timing signals ϕ2 and ϕ4 has the high level. When both timing signals ϕ2 and ϕ4 have the low level, however, analog switch 55 does not output the output of input switching unit 44 and DA conversion unit 48. The output of analog switch 55 is input to integration circuit 56. Integration circuit 56 includes is constituted by: operational amplifier 57, a pair of capacitors 58 and 59, and a pair of analog switches 60 and 61. Each of capacitors 58 and 59 is connected in parallel with operational amplifier 57 between feedback terminals, i.e., to an inversed input terminal and an output terminal of operational amplifier 57. Each of analog switches 60 and 61 is connected in series with respective one of capacitors 58 and 59. Analog switch 60 operates in response to timing signals ϕ1 and ϕ2, i.e., is turned on when one of timing signals ϕ1 and ϕ2 has the high level, and is turned off when both timing signals ϕ1 and ϕ2 have the low level. Integration circuit 56 integrates the signal input to integration circuit 56. An integral value obtained by the integration is stored in capacitor 58. Analog switch 61 operates in response to timing signals ϕ3 and ϕ4, i.e., is turned on when one of timing signals ϕ3 and ϕ4 has the high level, and is turned off when both timing signals ϕ3 and ϕ4 have the low level. Integration circuit 56 integrates the signal input to integration circuit 56. An integral value obtained by the integration is stored in capacitor 59. Analog switch 55 and integration circuit 56 constitute integration unit 62. Integration unit 62 integrates the output of analog switch 55 with capacitor 58, and outputs the resulting integral value when timing signals ϕ1 and ϕ2 have the high level. Integration unit 62 integrates the output of analog switch 55 with capacitor 59, and outputs the resulting integral value when timing signals ϕ3 and ϕ4 have the high level.

Comparator unit 63 includes comparator 64 and D-type flip flop 65. Comparator 64 compares the integral value output from integration unit 62 with a predetermined value, and outputs a one-bit digital signal. The one-bit digital signal output from comparator 64 is input to D-type flip flop 65. D-type flip flop 65 latches the one-bit digital signal and outputs the latched signal when periods P2 and P4 start, i.e., when one of timing signals ϕ2 and ϕ4 has the high level. The latched signal is input to DA switching unit 47 of DA conversion unit 48 to switch between reference voltages V49 and V50. Input switching unit 44, DA conversion unit 48, integration unit 62, and comparator unit 63 constitute ΣΔ-modulator 66.

ΣΔ-modulator 66 performs ΣΔ-modulation on the electric charge output from the pair of sense electrodes 34 and 35 of angular-velocity detection element 30 so as to convert the electric charge into a one-bit digital signal and output the one-bit signal.

Latch circuit 67 includes pair of D-type flip flops 68 and 69. The pair of D-type flip flops 68 and 69 latch the one-bit digital signal output from comparator 64 of comparator unit 63 of ΣΔ-modulator 66. D-type flip flop 68 latches the one-bit digital signal at the beginning of period P2, i.e., when timing signal ϕ2 rises to the high level from the low level. D-type flip flop 69 latches the one-bit digital signal at the beginning of period P4, i.e., when timing signal ϕ4 rises to the high level from the low level. The difference between the pair of one-bit digital signals latched and output from D-type flip flops 68 and 69 is calculated by one-bit difference calculation unit 70 to perform a one-bit difference calculation by a replacing process. In other words, values of “00”, “01”, “10”, and “11” of two-bit signals which are composed of the pair of one-bit digital signals input to one-bit difference calculation unit 70 are replaced by values of “0”, “−1”, “1”, and “0”, respectively, as one-bit difference signal S70, which is output. In accordance with the embodiment, D-type flip flop 68 constitutes the most significant bit (MSB) of the 2-bit signal, and D-type flip flop 69 constitutes the least significant bit (LSB) of the 2-bit signal. Correction processor 71 corrects, based on predetermined correction data, one-bit difference signal S70 output from one-bit difference calculation unit 70 so as to perform a correction calculation by a replacing process. In other words, as mentioned above, the values of one-bit difference signal S70 input to correction processor 71 are assumed to be “0”, “1”, and “−1”, and the value of the correction data is assumed to be, e.g. “5”. Upon having the values of one-bit difference signal S70, i.e., values of “0”, “1”, and “−1” input, correction processor 71 replaces the values of one-bit difference signal S70, i.e., “0”, “1”, and “−1” by digital difference signals serving as multi-bit signals of “0”, “5”, and “−5”, respectively, and outputs the multi-bit signals. Digital difference signal S71 output from correction processor 71 is input to digital filter 72 to perform a filtering process, i.e., remove noise components of digital difference signal S71. Latch circuit 67, one-bit difference calculation unit 70, correction processor 71, and digital filter 72 constitute calculation unit 73. At the beginning of periods P2 and P4, i.e., when timing signals ϕ2 and ϕ4 have the high level, calculation unit 73 latches the pair of one-bit digital signals, and performs the difference calculation, the correction calculation, and the filtering process, and then outputs digital difference signal S71 serving as the multi-bit signal. Timing control circuit 43, ΣΔ-modulator 66, and calculation unit 73 constitute sense circuit 74.

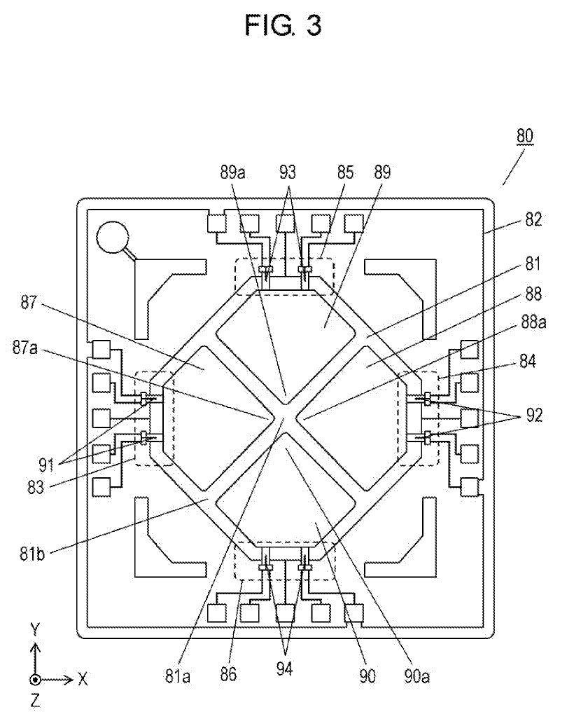

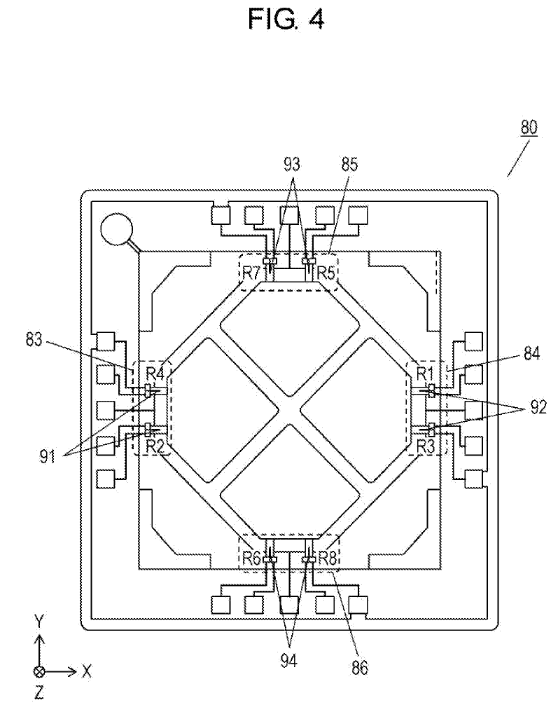

Acceleration sensor section 22 of composite sensor 1000 will be described below. FIGS. 3 and 4 are top views of acceleration detection element 80 of acceleration sensor section 22.

Acceleration detection element 80 includes frame 82 having hollow region 81 provided inside the frame and beams 83, 84, 85, and 86 each having an end connected to frame 82 and extending to hollow region 81 from the end. In FIGS. 3 and 4, an X-axis, a Y-axis, and a Z-axis perpendicularly crossing one another are defined. Beams 83 and 84 extend in a direction of the X-axis. Beams 85 and 86 extend in a direction of the Y-axis. Acceleration detection element 80 further includes weights 87, 88, 89, and 90 each connected to another end of respective one of beams 83, 84, 85, and 86, acceleration detectors 91 and 92 that detect acceleration in the direction of the X-axis, and acceleration detectors 93 and 94 that detect acceleration in the direction of the Y-axis. Acceleration detectors 91, 92, 93, and 94 are provided on beams 83, 84, and 85 and 86, respectively. Weights 87 and 88 are located opposite to each other while weights 89 and 90 are located opposite to each other. Acceleration detectors 91 to 94 may be implemented by, e.g. a strain resistance type of acceleration detector or a capacitive type of acceleration detector. The strain resistance type of acceleration detector employing piezo resistance provides acceleration detection element 80 with high sensitivity. The strain resistance type of acceleration detector employing a thin-film resistance type of acceleration detector provides acceleration detection element 80 with improved temperature characteristics.

FIG. 4 shows an arrangement of stain-sensitive resistors R1 to R8 of acceleration detectors 91 to 94 of the stain resistance type. Stain-sensitive resistors R2 and R4 constitute acceleration detector 91. Stain-sensitive resistors R1 and R3 constitute acceleration detector 92. Stain-sensitive resistors R5 and R7 constitute acceleration detector 93. Stain-sensitive resistors R6 and R8 constitute acceleration detector 94.

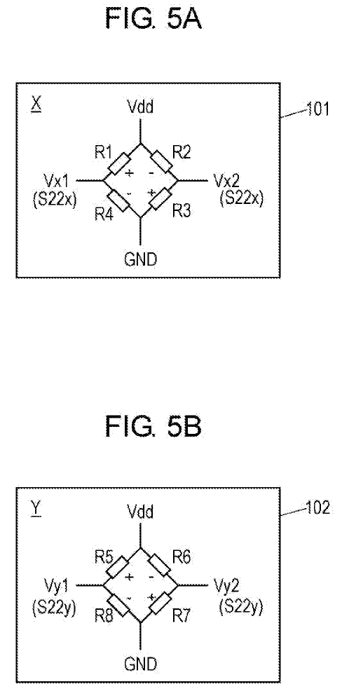

FIG. 5A is a circuit diagram of bridge circuit 101 that detects acceleration in the direction of the X-axis. One pair of nodes Vdd and GND opposite to each other and the other pair of nodes Vx1 and Vx2 opposite to each other provide a bridge connection of stain-sensitive resistors R1, R2, R3, and R4 so as to form bridge circuit 101. While a voltage is applied across nodes Vdd and GND, a voltage between nodes Vx1 and Vx2 is detected, thereby determining the acceleration in the direction of the X-axis. Bridge circuit 101 thus processes output signals from acceleration detectors 91 and 92 to output acceleration in the direction of the X-axis.

FIG. 5B is a circuit diagram of bridge circuit 102 that detects acceleration in the direction of the Y-axis. One pair of nodes Vdd and GND opposite to each other and the other pair of nodes Vy1 and Vy2 opposite to each other provide a bridge connection of stain-sensitive resistors R5, R6, R7, and R8 so as to form bridge circuit 102. While a voltage is applied across the pair of nodes Vdd and GND, a voltage between the pair of node Vy1 and Vy2 is detected, thereby determining the acceleration in the direction of the Y-axis. Bridge circuit 102 processes output signals from acceleration detectors 93 and 94 to output acceleration in the direction of the Y-axis.

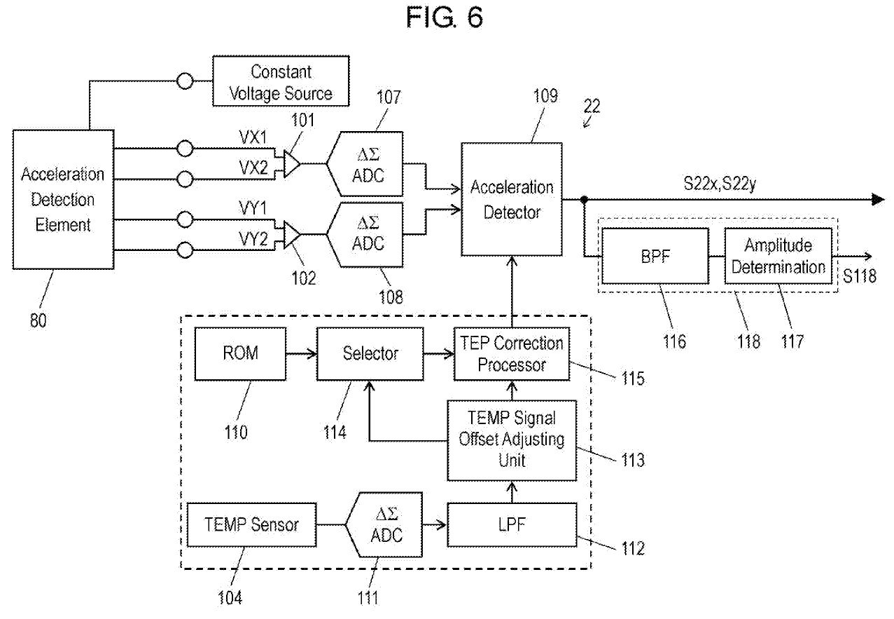

FIG. 6 is a circuit block diagram of acceleration sensor section 22.

Temperature sensor 104 detects temperature around acceleration detection element 80, and outputs temperature date corresponding to the detected temperature.

ΔΣ-type A/D converter 107 converts the output signal, an analog signal, from bridge circuit 101 into a digital signal, and outputs the digital signal. ΔΣ-type A/D converter 108 converts the output signal, an analog signal, from bridge circuit 102 into a digital signal, and outputs the digital signal. In acceleration detection circuit 109, the acceleration signal from ΔΣ-type A/D converter 107 indicates the acceleration in the direction of the X-axis. The acceleration signal from ΔΣ-type A/D converter 108 indicates the acceleration in the direction of the Y-axis. The acceleration signal from ΔΣ-type A/D converter 107 and the acceleration signal from ΔΣ-type A/D converter 108 are corrected based on the temperature data from temperature sensor 104, and are output.

Bandpass filter (BPF) 116 passes substantially only a component of the acceleration signal with a predetermined frequency output from acceleration detection circuit 109, and outputs the component. Amplitude determination circuit 117 determines an amplitude of the signal output from bandpass filter 116. When the determined amplitude is more than or equal to a predetermined threshold, amplitude determination circuit 117 outputs a self-diagnostic output signal. When the amplitude is smaller than the predetermined threshold, amplitude determination circuit 117 does not output the self-diagnostic output signal.

Bandpass filter 116 and amplitude determination circuit 117 constitute stability determination circuit 118.

An operation of angular velocity sensor section 21 of composite sensor 1000 in accordance with the embodiment will be described below.

An alternating-current (AC) voltage applied to drive electrode 32 of angular-velocity detection element 30 causes vibration body 31 to resonate, i.e., to bend and vibrate in drive direction Dd at resonance frequency fd, so that signal S33, an electric charge, is generated on monitor electrode 33. Resonance frequency fd is a resonance frequency in drive direction Dd. Signal S33 (electric charge) generated on monitor electrode 33 is input to charge amplifier 36 of drive circuit 40, and converted into an output voltage changing along a sine wave. The output voltage from charge amplifier 36 is input to bandpass filter 37. Bandpass filter 37 extracts only a component of the output signal with a resonance frequency of vibration body 31 so as to remove a noise component from the output signal, and then, outputs monitor signal S37 changing along a sine wave shown in FIG. 2B. Monitor signal S37 is input to a half-wave rectification smoothing circuit of AGC circuit 38, and converted into a direct current (DC) signal. When the DC signal increases, a signal for attenuating monitor signal S37 output from bandpass filter 37 is output to drive circuit 39 from AGC circuit 38. On the other hand, when the DC signal decreases, a signal for amplifying monitor signal S37 is output to drive circuit 39 from AGC circuit 38. With the operation, vibration body 31 is adjusted to vibrate with a fixed amplitude. Monitor signal S37 is input to timing control circuit 43 of sense circuit 74. The frequency of monitor signal S37 is multiplied by PLL circuit 41 and the frequency-multiplied signal is output. Timing generator 42 generates timing signals ϕ1, ϕ2, ϕ3, and ϕ4 shown in FIG. 2B based on the signal output from PLL circuit 41. Timing signals ϕ1, ϕ2, ϕ3, and ϕ4 are input to ΣΔ-modulator 66 and calculation unit 73 as a signal to determine the timing for switching of the analog switches and latching of the latch circuits.

Timing signals ϕ1, ϕ2, ϕ3, and ϕ4 may be generated by the following method. Monitor signal S37 with a sine-wave shape is phase-shifted by 90 degrees with a phase shifter to generate a phase-shifted signal. Monitor signal S37 and the phase-sifted signal are input to a comparator for comparing with a predetermined reference voltage, and an output of the comparator is input to a logic circuit. The logic circuit outputs timing signals ϕ1, ϕ2, ϕ3, and ϕ4. In this case, a random noise of monitor signal S37 with a sine-wave shape and a voltage noise caused by temperature change or a power supply variation appear as a phase noise. The phase noise may adversely affect accuracy of signal processing as a timing noise produced at the time of input-signal switching or integration switching. If timing signals ϕ1, ϕ2, ϕ3, and ϕ4 are generated by PLL circuit 41 shown in FIG. 2A, monitor signal S37 is integrated over time to reduce a phase noise, a switching timing noise is reduced, and the accuracy of signal processing will be improved. While angular-velocity detection element 30 bends and vibrates in drive direction Dd shown in FIG. 2A at speed V, if angular-velocity detection element 30 (vibration body 31) rotates at angular velocity ω about a central axis extending in a longitudinal direction of vibration body 31, Coriolis force F expressed by F=2mV×ω is produced in angular-velocity detection element 30 in detection direction Dt. When vibration body 31 bends and vibrates in detection direction Dt due to Coriolis force F, electric charges are generated on sense electrodes 34 and 35 of angular-velocity detection element 30. These electric charges produce sense signals S34 and S35 shown in FIG. 2B. Sense signals S34 and S35 caused due to the electric charges generated on sense electrodes 34 and 35 are generated due to Coriolis force F. Therefore, the phases of sense signals S34 and S35 advance by 90 degrees relative to monitor signal S37 obtained from monitor electrode 33. As shown in FIG. 2B, sense signals S34 and S35 generated on sense electrodes 34 and 35 are signals with positive and negative polarities with phases opposite to each other, respectively.

An operation of EA-modulator 66 while sense signals S34 and S35 shown in FIG. 2B are generated on sense electrodes 34 and 35, the operation of ΣΔ-modulator 66 will be described below. ΣΔ-modulator 66 operates while repeating periods P1 to P4 determined by timing signals ϕ1 to ϕ4 in this order. During periods P1 and P2, i.e., when timing signals ϕ1 and ϕ2 have the high level, sense signal S34 with a positive polarity output from sense electrode 34 is ΣΔ-modulated and converted into a one-bit digital signal. During periods P3 and P4, i.e., when timing signals ϕ3 and ϕ4 have the high level, sense signal S35 with a negative polarity output from sense electrode 35 is ΣΔ-modulated and converted into a one-bit digital signal.

The operation will be described below for each of periods P1 to P4 determined by four timing signals ϕ1 to ϕ4.

First, during period P1, i.e., when timing signal ϕ1 has the high level, analog switch 60 connected to capacitor 58 of integration unit 62 is turned on. The integral value stored in capacitor 58 is input to comparator 64 of comparator unit 63, and the comparison result of comparator 64 is output as a one-bit digital signal. Analog switches 53 and 54 of DA conversion unit 48 are turned on, and the electric charge stored in capacitor 52 is discharged.

Next, during period P2, i.e., when timing signal ϕ2 has the high level, the one-bit digital signal output from comparator 64 of comparator unit 63 is latched by D-type flip flop 65 at the timing of rising of timing signal ϕ2, and is output as a latched signal. The latched signal is input to DA switching unit 47 of DA conversion unit 48. Reference voltages V49 and V50 are switched in response to the input latched signal, and the selected reference voltage is input to capacitor 52. Thus, an electric charge due to the reference voltage input from DA conversion unit 48 is output. At the same time, analog switch 45 of input switching unit 44 is turned on, and sense signal S34 caused by the electric charge generated on sense electrode 34 of angular-velocity detection element 30 is output. Furthermore, analog switch 55 of integration unit 62 is turned on, and the electric charge output from input switching unit 44 and DA conversion unit 48 is input to integration circuit 56. Thus, during period P2, a total of electric charge Q134 and the electric charge output from DA conversion unit 48 is integrated, and stored in capacitor 58 of integration circuit 56. Electric charge Q134 is denoted by the slashed area of sense signal S34 in FIG. 2B.

With the above-mentioned operations during periods P1 and P2, i.e., when timing signals ϕ1 and ϕ2 have the high level, electric charge Q134 which is equivalent to a half of the amplitude of sense signal S34 output from sense electrode 34 of angular-velocity detection element 30 is ΣΔ-modulated, and is output as a one-bit digital signal at the beginning of periods P1 and P2, i.e., when timing signals ϕ1 and ϕ2 rise.

Similarly to the above-mentioned operations during periods P1 and P2, during periods P3 and P4, i.e., when timing signals ϕ3 and ϕ4 have the high level, electric charge Q135 which is equivalent to a half of the amplitude of sense signal S35 output from sense electrode 35 of angular-velocity detection element 30 is ΣΔ-modulated, converted into a one-bit digital signal, and output at the beginning of periods P3 and P4 i.e., when timing signals ϕ3 and ϕ4 rise. With the above-mentioned operations, electric charges Q134 and Q135 are ΣΔ-modulated by single ΣΔ-modulator 66, and output as a pair of one-bit digital signals at the above timing. Electric charges Q134 and Q135 are equivalent to halves of amplitudes of sense signals S34 and S35 output from sense electrodes 34 and 35 of angular-velocity detection element 30.

The electric charges output from the pair of sense electrodes 34 and 35 of angular-velocity detection element 30 further contain not only sense signals S34 and S35 resulting from Coriolis force F produced due to angular velocity ω, but also unnecessary signals U34 and U35 having phases identical to that of monitor signal S37 shown in FIG. 2B, respectively. An operation of angular velocity sensor section 21 in which mixture signals which contain sense signals S34 and S35 and unnecessary signals U34 and U35 added to sense signals S34 and S35 are output from the pair of sense electrodes 34 and 35 in angular-velocity detection element 30 will be described. As described above, electric charge Q134 which is equivalent to a half of the amplitude of sense signals S34 and S35 resulting from Coriolis force F produced due to angular velocity ω is integrated by integration circuit 56 during periods P2 and P4, i.e., when timing signals ϕ2 and ϕ4 have the high level. For unnecessary signals U34 and U35 generated on sense electrodes 34 and 35, electric charge Q234 is integrated from the maximum value to the minimum value of the amplitude of unnecessary signal U34 during period P2, and electric charge Q235 is integrated from the minimum value to the maximum value of the amplitude of unnecessary signal U35 during period P4, similarly to sense signals S34 and S35. Accordingly, each of electric charges Q234 and Q235 is cancelled to be zero upon being integrated. In other words, integration unit 62 during periods P2 and P4 cancels unnecessary signals U34 and U35, so that electric charge according to the amplitude of sense signals S34 and S35 is integrated, i.e., so-called a synchronous detection process is performed on each of the signals input from the pair of sense electrodes 34 and 35. Therefore, similarly to the operation for a signal not containing unnecessary signals U34 and U35, the synchronously-detected signal is EA-modulated and converted into a one-bit digital signal, and then, is output from EA-modulator 66.

The above operation allows angular velocity sensor section 21 to perform the EA-modulation of the pair of signals output from angular-velocity detection element 30 while performing the synchronous detection. A digital value of the synchronously-detected signal can be obtained without analog circuits, such as an IV converter, a phase shifter, and a synchronous detection circuit. In addition to this, the above operation can also be achieved with a very small circuit scale compared with the above-mentioned analog circuits, i.e., using a small sized and low cost circuit.

An operation of calculation unit 73 will be described below. First, at the beginning of period P2 i.e., when timing signal ϕ2 rises, the one-bit digital signal output from comparator 64 of comparator unit 63 of ΣΔ-modulator 66 is latched by D-type flip flop 68 of latch circuit 67, and is output as one-bit digital signal S68. At the beginning of period P4 i.e., when timing signal ϕ4 rises, the one-bit digital signal output from comparator 64 of comparator unit 63 of ΣΔ-modulator 66 is latched by D-type flip flop 69 of latch circuit 67, and is output as one-bit digital signal S69.

As described above, one-bit digital signals S68 and S69 latched by

D-type flip flops 68 and 69 are obtained by converting the electric charges which are equivalent to halves of amplitudes of sense signals S34 and S35 into digital values through the ΣΔ-modulation, respectively. Sense signals S34 and S35 are obtained by subtracting unnecessary signals U34 and U35 from sense electrodes 34 and 35 of angular-velocity detection element 30, respectively. Then, one-bit digital signals S68 and S69 output from latch circuit 67 are input to one-bit difference calculation unit 70. Then, a difference between one-bit digital signals S68 and S69 is calculated, and one-bit difference signal S70 is output. One-bit difference signal S70 during period P1 is the difference between one-bit digital signals S68 and S69 latched during the last periods P2 and P4, respectively. One-bit difference signal S70 indicates amplitude values of sense signals S34 and S35, shown in FIG. 2B, that are obtained by subtracting unnecessary signals U34 and U35 from the signals output from sense electrodes 34 and 35 of angular-velocity detection element 30. With the above-mentioned operations, sense signals S34 and S35 which are positive and negative polarity signals output from sense electrodes 34 and 35 of angular-velocity detection element 30 are integrated by single integration unit 62. Thus, an influence of relative errors on the result obtained by integrating the input signals which depends on variation in characteristic of each integration unit is drastically reduced as compared with the case where sense signals S34 and S35 are integrated individually by two integration units. Further, a single (the same) DA conversion unit 48 is employed to process the pair of input signals. Further, in terms of comparator unit 63, a pair of integration results are also compared with one reference voltage by a single comparator. Thus, an influence of relative errors on the comparison result which depends on characteristic of comparators or variation in reference voltages is drastically reduced. As mentioned above, a pair of input signals are processed by a single integration unit, a single DA conversion unit, and a single comparator unit. Thus, as compared with the case where signal processing is performed by the above-mentioned components, an influence of relative errors on each of the above-mentioned components is drastically reduced.

Similarly, an influence of variation in reference voltage on each of the above-mentioned components which depends on power-supply-voltage change or temperature change is also applied to the pair of input signals. Accordingly, if a difference between the pair of input signals subjected to signal processing is calculated by one-bit difference calculation unit 70 of calculation unit 73, the influence of variation in reference voltages on each of the above-mentioned components can be cancelled. This configuration can perform AD conversion of the difference between the pair of input signals accurately. In-phase noises or offsets are contained in the pair of input signals output from the pair of sense electrodes 34 and 35 of angular-velocity detection element 30 and input to a ΣΔ-type AID converter. An influence of the in-phase noises or offsets can also be cancelled, simultaneously. Further, the one-bit difference calculation, i.e., the calculation of a difference between the pair of input signals is performed such that, if the output signal of the comparator unit is a one-bit signal that takes values of “1” and “0,” the values of a pair of comparison signals input to one-bit difference calculation unit 70 are restricted to four values, i.e., “00”, “01”, “10”, and “11”, and the calculation results of the difference are also previously determined to be “0”, “−1”, “1”, and “0”. This configuration allows sense circuit 74 to perform one-bit digital calculation with a simple circuit configuration, i.e., obtain a result in which subtraction processing according to an input signal is performed, without an arithmetic unit for performing addition and subtraction. After the pair of input signals subjected to the subtraction processing is obtained as a difference signal, signal processing is performed. Herein, the signal processing includes low pass filtering or decimation by a digital filter, which is often required in ΣΔ type A/D conversion.

Next, one-bit difference signal S70 output from one-bit difference calculation unit 70 is input to correction processor 71 to perform correction calculation through replacing process. In the correction calculation, one-bit difference signal S70 is corrected based on predetermined correction data. As described above, the correction calculation is performed utilizing the fact that the value of one-bit difference signal S70 is restricted to three values, “0”, “1”, and “−1”. In other words, if a value of predetermined correction data is R, the values of one-bit difference signal S70, i.e., “0”, “1”, and “−1” are replaced by “0” “R” and “−1×R,” respectively, to perform multiplying, thereby enabling signal correction. For instance, if a value of correction data is “5”, the values of one-bit difference signal S70 to be input to correction processor 71, i.e., “0”, “1”, and “−1” are replaced by values of “0”, “5”, and “−5”, respectively, to perform multiplying, thereby enabling signal correction.

This configuration corrects variation in sensitivity to the angular velocity caused due to manufacturing variations of angular-velocity detection element 30, or variation in sensitivity of angular-velocity detection element 30 caused by temperature change if the correction data is determined suitably. Furthermore, after digital difference signal 71 is converted into a multi-bit signal by a digital filter, the multi-bit signal is multiplied by a multiplier and output as angular velocity signal S21.

An operation of acceleration sensor section 22 will be described below.

First, an operation of acceleration sensor section 22 detecting acceleration in the direction of the X-axis will be described.

Acceleration applied to acceleration detection element 80 in a positive direction of the X-axis causes weight 88 to move downward in a negative direction of the Z-axis. On the other hand, weight 87 moves upward in the positive direction of the Z-axis. Thus, a tensile stress is applied to an upper surface of beam 84, so that resistances of stain-sensitive resistors R1 and R3 of acceleration detector 92 increase. Further, compression stress is applied to an upper surface of beam 83, so that resistances of stain-sensitive resistors R2 and R4 of acceleration detector 91 decrease. Accordingly, acceleration signal S22x changing according to the acceleration applied in the direction of the X-axis is output from bridge circuit 101 shown in FIG. 5A.

Then, an operation of acceleration sensor section 22 detecting acceleration in the direction of the Y-axis will be described.

Acceleration applied to acceleration detection element 80 in a positive direction of the Y-axis causes weight 89 to move downward. On the other hand, weight 90 moves upward. Thus, a tensile stress is applied to an upper surface of beam 85, so that resistances of stain-sensitive resistors R5 and R7 of acceleration detector 93 increase. Further, a compression stress is applied to an upper surface of beam 86, so that resistances of stain-sensitive resistors R6 and R8 of acceleration detector 94 decrease. Accordingly, acceleration signal S22y changing according to the acceleration applied in the direction of the Y-axis is output from bridge circuit 102 shown in FIG. 5B.

Accelerations in directions of two axes, the X-axis and the Y-axis, are applied to the acceleration sensor, simultaneously. An output signal output from bridge circuit 101 corresponding to acceleration in the direction of the X-axis is converted into a digital signal by ΔΣ-type AD converter 107.

Similarly, an output signal output from bridge circuit 102 corresponding to acceleration in the direction of the Y-axis is converted into a digital signal by ΔΣ-type AD converter 108. In acceleration detection circuit 109, a sensor output signal output from ΔΣ-type AD converter 107 which is a digital signal corresponding to the acceleration in the direction of the X-axis and a sensor output signal output from ΔΣ-type AD converter 108 which corresponds to the acceleration in the direction of the Y-axis are corrected based on temperature data output from temperature sensor 104, and are output as acceleration signal S22x of the X-axis and acceleration signal S22y of the Y-axis, respectively.

Timing control circuit 43 outputs sensor output signal S43, a digital signal, based on angular velocity signal S21 output from angular velocity sensor section 21, acceleration signals S22x and S22y output from acceleration sensor section 22, and self-diagnostic signal S118 output from stability determination circuit 118.

An operation of composite sensor 1000 in accordance with the embodiment having vibration applied from the outside will be described.

First, an operation of composite sensor 1000 having a mechanical external force including vibration in the direction of the X-axis applied thereto will be described.

Acceleration sensor section 22 outputs acceleration signal S22x in response to an external force in the direction of the X-axis among mechanical external forces applied thereto. Acceleration signal S22x is output via timing control circuit 43. Acceleration signal S22x is also input to bandpass filter 116. Bandpass filter 116 passes substantially only a component of acceleration signal S22x with a predetermined passing frequency, and outputs the component as signal S116. Components other than the component with the predetermined passing frequency do not pass through bandpass filter 116 substantially, so that no signals are output.

Vibration body 31 of angular-velocity detection element 30 of angular velocity sensor section 21 vibrates in drive direction Dd at resonance frequency fd of vibration body 31 in drive direction Dd in response to drive signal S39 which is an AC voltage applied to drive electrode 32. When angular velocity is applied to angular-velocity detection element 30 while vibration body 31 vibrates in drive direction Dd, vibration body 31 bends and vibrates in detection direction Dt due to Coriolis force F caused due to the angular velocity synchronously with the vibration in drive direction Dd. Therefore, a drive frequency which is the frequency of drive signal S39 is equal to resonance frequency fd of vibration body 31 in drive direction Dd, and also equal to a frequency at which vibration body 31 vibrates in detection direction Dt due to Coriolis force F. In other words, a drive frequency is a resonance frequency of vibration body 31 at which vibration body 31 vibrates mechanically in drive direction Dd. A detection frequency of vibration body 31 is a resonance frequency of vibration body 31 at which vibration body 31 vibrates mechanically in detection direction Dt. The drive frequency may not be identical to detection frequency, and may be different from the detection frequency. When a vibration with a detuning frequency which is a difference between the drive frequency and the detection frequency is applied to composite sensor 1000, the vibration with the detuning frequency affects the vibration in detection direction Dt of vibration body 31 of angular-velocity detection element 30. This configuration prevents angular velocity signal S21 output by angular velocity sensor section 21 from indicating a correct angular velocity, so that incorrect angular velocity signal S21 may be output. For instance, if a vibration with the detuning frequency is applied to composite sensor 1000 while no angular velocity is applied thereto, vibration body 31 of angular-velocity detection element 30 vibrates in detection direction Dt as if any angular velocity is applied to composite sensor 1000, so that sense signals S34 and S35 may be generated from sense electrodes 34 and 35.

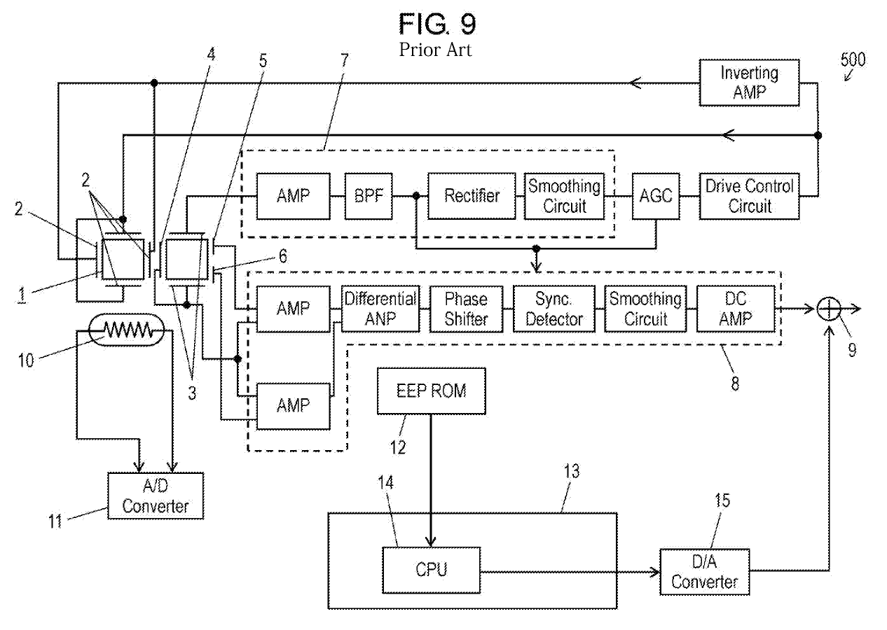

For instance, in conventional angular velocity sensor 500 shown in FIG. 9, if a vibration with the detuning frequency which is a difference between the drive frequency and the detection frequency is applied to angular-velocity detection element 1 while, for example, no angular velocity is applied thereto from the outside, angular-velocity detection element 1 resonates. Accordingly, an output signal is generated from sense electrodes 5 and 6 of angular-velocity detection element 1 as if an angular velocity is applied to angular-velocity detection element 1, so that an unnecessary signal is generated from the sense circuit.

The passing frequency, i.e., the frequency of the component passing through bandpass filter 116 is determined to be the detuning frequency. In accordance with the embodiment, the drive frequency is about 39.8 kHz, and the detection frequency is about 38.8 kHz. Therefore, the detuning frequency is about 1 kHz. When the amplitude of signal S116 output from bandpass filter 116 is more than or equal to a predetermined threshold, amplitude determination circuit 117 outputs, to timing control circuit 43, self-diagnostic signal S118 indicating that angular velocity signal S21 is incorrect, i.e., invalid. When the amplitude of signal S116 is smaller than the predetermined threshold, amplitude determination circuit 117 does not output self-diagnostic signal S118 to timing control circuit 43. In other words, self-diagnostic signal S118 prevents timing control circuit 43 from outputting incorrect angular velocity signal S21 from angular velocity sensor section 21. In accordance with the embodiment, the predetermined threshold is a value of acceleration signal S22x corresponding to an acceleration of 1.0 m/s².

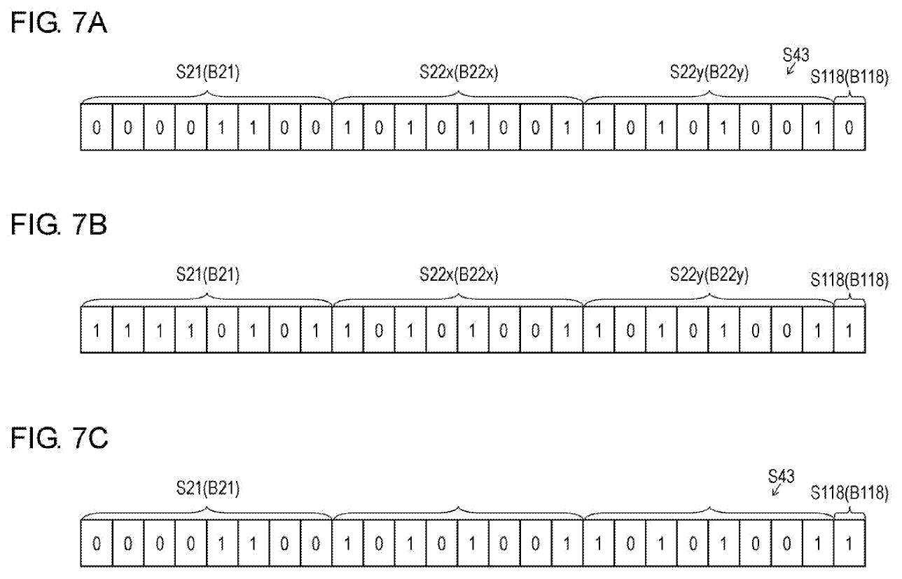

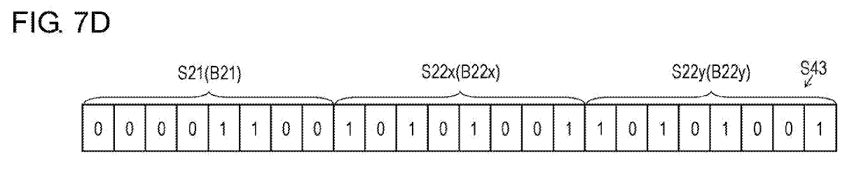

FIGS. 7A to 7C show sensor output signals S43 output from timing control circuit 43. As shown in these figures, sensor output signal S43 is a multi-bit digital signal including bits B21 composed of plural bits indicating angular velocity signal S21, bits B22x composed of plural bits indicating acceleration signal S22x, bits B22y composed of plural bits indicating acceleration signal S22y, and flag B118 that is based on self-diagnostic signal S118. When self-diagnostic signal S118 is output, the value of flag B118 is an active value of “1.” When self-diagnostic signal S118 is not output, the value of flag B118 is a non-active value of “0.”

If a vibration with a frequency different from the detuning frequency is applied from the outside, bandpass filter 116 does not pass acceleration signal S22x generated due to the vibration. Accordingly, self-diagnostic signal S118 is not output to amplitude determination circuit 117. Timing control circuit 43 outputs sensor output signal S43 including flag B118 having the non-active value of “0” shown in FIG. 7A. In other words, all of angular velocity signal S21 and acceleration signals S22x and S22y are output from timing control circuit 43 as correct values.

While timing control circuit 43 outputs sensor output signal S43 shown in FIG. 7A, if a vibration with a frequency substantially identical to the detuning frequency is applied from the outside, bandpass filter 116 passes and outputs acceleration signal S22x as signal S116. When the amplitude of signal S116 is more than or equal to a predetermined threshold, amplitude determination circuit 117 outputs self-diagnostic signal S118. Timing control circuit 43 updates flag B118 to change into the active value of “1” in response to self-diagnostic signal S118, so that sensor output signal S43 changes to have the configuration shown in FIG. 7B. At least angular velocity signal S21 in sensor output signal S43 shown in FIG. 7B is incorrect. When self-diagnostic signal S118 is output, timing control circuit 43 holds bits B21 indicated by angular velocity signal S21 shown in FIG. 7A which is the signal immediately before self-diagnostic signal S118 is output, and outputs sensor output signal S43 shown in FIG. 7C, not outputting sensor output signal S43 shown in FIG. 7B. Sensor output signal S43 shown in FIG. 7C shows that the value of flag B118 is the active value of “1,” and the values of bits B21 indicating angular velocity signal S21 are the values immediately before the value of flag B118 changes into the active value of “1.”

Next, an operation of composite sensor 1000 having mechanical external force including a vibration in the direction of the Y-axis applied thereto will be described.

Acceleration sensor section 22 outputs acceleration signal S22y in response to an external force in the direction of the Y-axis among the mechanical external forces applied thereto. Acceleration signal S22y is output via timing control circuit 43. Bandpass filter 116 passes a component of acceleration signal S22y with the predetermined passing frequency, and outputs the component as signal S116. Components other than the component with the passing frequency do not pass through bandpass filter 116, so that no signals are output. When the amplitude of signal S116 output from bandpass filter 116 is more than or equal to a predetermined threshold, amplitude determination circuit 117 outputs, to timing control circuit 43, self-diagnostic signal S118 indicating that angular velocity signal S21 is incorrect. When the amplitude of signal S116 is smaller than the predetermined threshold, amplitude determination circuit 117 does not output self-diagnostic signal S118 to timing control circuit 43. In other words, self-diagnostic signal S118 prevents timing control circuit 43 from outputting incorrect angular velocity signal S21 from angular velocity sensor section 21.

In composite sensor 1000 according to the embodiment, if the amplitude of a component of at least one of acceleration signals S22x and S22y with the passing frequency of bandpass filter 116 is more than or equal to a predetermined threshold, amplitude determination circuit 117 outputs, to timing control circuit 43, self-diagnostic signal S118 indicating that angular velocity signal S21 is incorrect. If both of the amplitudes of the components of acceleration signals S22x and S22y with the passing frequency of bandpass filter 116 are smaller than the predetermined threshold, amplitude determination circuit 117 does not output self-diagnostic signal S118 to timing control circuit 43.

In composite sensor 1000 according to the embodiment, if the sum of squares of the amplitudes of components of acceleration signals S22x and S22y with the passing frequency of bandpass filter 116 is more than or equal to the predetermined threshold, amplitude determination circuit 117 may output, to timing control circuit 43, self-diagnostic signal S118 indicating that angular velocity signal S21 is incorrect. If the sum of squares of the amplitudes is smaller than the predetermined threshold, amplitude determination circuit 117 may not output self-diagnostic signal S118 to timing control circuit 43.

Thus, even if a vibration with the detuning frequency is applied to composite sensor 1000 while no angular velocity is applied thereto, sense signals S34 and S35 are not generated from sense electrodes 34 and 35 as if an angular velocity is applied to composite sensor 1000. Thus, incorrect angular velocity signal S21 resulting from sense signals S34 and S35 can be prevented, based on the output of acceleration sensor section 22, from being output.

As shown in FIG. 1, timing control circuit 43 is connected to functional device 1001, such as a vehicle and a game machine. Functional device 1001 receives sensor output signal S43 and operates based on the angular velocity and acceleration indicated by sensor output signal S43. Sensor output signals S43 shown in FIGS. 7A to 7C include flag B118 that is based on self-diagnostic signal S118. It is determined instantaneously based on flag B118 whether bits B21 of sensor output signal S43 are correct or not.

FIG. 7D shows sensor output signal S43 output from composite sensor 1000 in accordance with the embodiment. In FIG. 7D, items identical those of sensor output signals 43 shown in FIGS. 7A to 7C are denoted by the same reference numerals. Sensor output signal S43 shown in FIG. 7D does not include flag B118 that changes in response to self-diagnostic signal S118. If it is not necessary to notify the outside that angular velocity signal S21 is incorrect, sensor output signal S43 may not necessarily include flag B118.

Regardless of angular velocity, vibration body 31 of angular-velocity detection element 30 vibrates due to not only a vibration with the detuning frequency but also a vibration with the detection frequency or the drive frequency. The passing frequency of bandpass filter 116 may be determined to be the drive frequency or the detection frequency. This configuration prevents incorrect angular velocity signal S21 from being output.

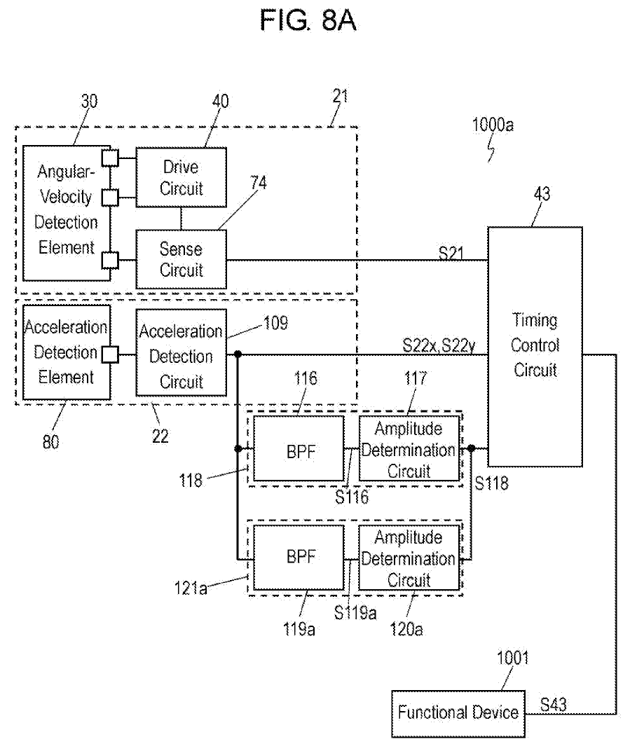

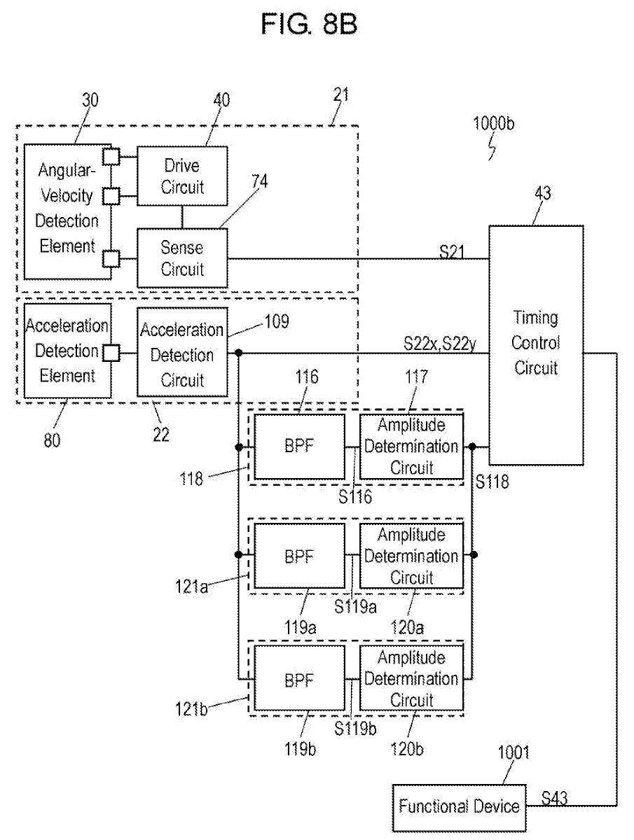

FIG. 8A is a block diagram of another composite sensor 1000a in accordance with the embodiment. In FIG. 8A, components identical to those of composite sensor 1000 shown in FIG. 1 are denoted by the same reference numerals. Composite sensor 1000a shown in FIG. 8A further includes bandpass filter 119a and amplitude determination circuit 120a. Bandpass filter 119a is connected in parallel with bandpass filter 116 and amplitude determination circuit 117. Stability determination circuit 121a includes bandpass filter 119a and amplitude determination circuit 120a. Like bandpass filter 116, bandpass filter 119a passes only a component of acceleration signal S22x (S22y) with a predetermined passing frequency and outputs the component as signal S119a. Components other than the component with the passing frequency do not pass through bandpass filter 119a, so that no signals are output. Like amplitude determination circuit 117, amplitude determination circuit 120a outputs self-diagnostic signal S118 when the amplitude of signal S119a is more than or equal to a predetermined threshold. When the amplitude of signal S119a is smaller than the predetermined threshold, amplitude determination circuit 120a does not output self-diagnostic signal S118. The passing frequency of bandpass filter 119a is determined to be the drive frequency. Thus, even if composite sensor 1000a receives a vibration with detuning frequency and a vibration with the drive frequency, timing control circuit 43 can be prevented from outputting incorrect angular velocity signal S21. The passing frequency of bandpass filter 119a may be determined to be the detection frequency. Alternatively, the passing frequency of bandpass filter 116 may be determined to be the drive frequency, and the passing frequency of bandpass filter 119a may be determined to be the detection frequency. This configuration provides the same effect.

FIG. 8B is a block diagram of still another composite sensor 1000b in accordance with the embodiment. In FIG. 8B, components identical to those of composite sensors 1000 and 1000a shown in FIGS. 1 and 8A are denoted by the same reference numerals. Composite sensor 1000b shown in FIG. 8B further includes bandpass filter 119b and amplitude determination circuit 120b. Bandpass filter 119b is connected in parallel with bandpass filters 116 and 119a and amplitude determination circuits 117 and 120a. Stability determination circuit 121b includes bandpass filter 119b and amplitude determination circuit 120b. Like bandpass filters 116 and 119a, bandpass filter 119b passes only a component of acceleration signal S22x (S22_{y}) with a predetermined passing frequency, and outputs the component as signal S119b. Components other than the component with the passing frequency do not pass through bandpass filter 119, so that no signals are output. Like amplitude determination circuits 117 and 120a, amplitude determination circuit 120b outputs self-diagnostic signal S118 when the amplitude of signal S119b is more than or equal to a predetermined threshold. When the amplitude of signal S119b is smaller than the predetermined threshold, amplitude determination circuit 120b does not output self-diagnostic signal S118. The passing frequency of bandpass filter 119b is determined to be the detection frequency. Thus, even if vibrations with the detuning frequency, the drive frequency, and the detection frequency are applied, timing control circuit 43 can be prevented from outputting incorrect angular velocity signal S21.

As described above, an angular-velocity detection element 30 includes a vibration body 31, a drive electrode 32 that receives a drive signal S39 so as to cause the vibration body 31 to vibrate, a sense electrode 34 (35) that outputs a sense signal S34 (S35) according to an angular velocity applied to the vibration body 31 while the vibration body 31 vibrates, and a monitor electrode 33 that outputs a monitor signal S37 according to vibration of the vibration body 31. A drive circuit 40 inputs the drive signal S39 to the drive electrode 32 of the angular-velocity detection element 30 based on the monitor signal S37, A sense circuit 74 outputs, based on the sense signal S34 (S35), an angular velocity signal S21 indicating the angular velocity. An acceleration detection circuit 109 outputs, based on a signal output from an acceleration detection element 80, an acceleration signal S22x indicating acceleration. The acceleration signal S22x is input to a bandpass filter 116. An amplitude determination circuit 117 determines, based on an amplitude of a signal S116 output from the bandpass filter 116, whether or not the angular velocity signal S21 is invalid. A timing control circuit 43 outputs a sensor output signal S43 including the angular velocity signal S21 and the acceleration signal S22x.

The amplitude determination circuit 117 may be configured to determine that the angular velocity signal S21 is invalid when the amplitude of the signal S116 is more than or equal to a predetermined threshold. In this case, the amplitude determination circuit 117 is configured to determine that the angular velocity signal S21 is not invalid when the amplitude of the signal S116 is smaller than the predetermined threshold.

The drive electrode 32 receives the drive signal S39 to cause the vibration body 31 to vibrate at a drive frequency. The vibration body 31 may resonate at a detection frequency different from the drive frequency. The bandpass filter 116 may pass substantially only a component of the acceleration signal S22x with a predetermined passing frequency, and outputs the component as the signal S116. The predetermined passing frequency of the bandpass filter 116 may be a detuning frequency that is a difference between the drive frequency and the detection frequency.

The acceleration signal S22x is input to a bandpass filter 119a. An amplitude determination circuit 117 determines, based on an amplitude of a signal S119a output from the bandpass filter 119a, whether or the angular velocity signal S21 is invalid. In this case, the bandpass filter 119a passes substantially only a component of the acceleration signal S22x with a passing frequency different from the predetermined passing frequency of the acceleration signal S22x, and outputs the component with the passing frequency as the signal S119a.

When the amplitude determination circuit 117 determines that the angular velocity signal S21 is invalid, the timing control circuit 43 holds a value of the angular velocity signal S21 immediately before the amplitude determination circuit 117 determines that the angular velocity signal S21 is invalid. In this case, the sensor output signal S43 may include the held value of the angular velocity signal S21.

The sensor output signal S43 may further include a self-diagnostic signal S118 (flag B118) indicating whether the angular velocity signal S21 is invalid or not.

Timing control circuit 43 may output self-diagnostic signal S118 (flag B118) indicating whether the angular velocity signal S21 is invalid or not.

### REFERENCE MARKS IN THE DRAWINGS

21 angular velocity sensor section
32 drive electrode
33 monitor electrode
34, 35 sense electrode
30 angular-velocity detection element
109 acceleration detection circuit
80 acceleration detection element
40 drive circuit
74 sense circuit
43 timing control circuit
116, 119a, 119b bandpass filter
117, 120a, 120b amplitude determination circuit
118, 121a, 121b stability determination circuit
1000, 1000a, 1000b composite sensor

1. A composite sensor comprising:
an angular-velocity detection element including
a vibration body,
a drive electrode that receives a drive signal so as to cause the vibration body to vibrate,
a sense electrode that outputs a sense signal according to an angular velocity applied to the vibration body while the vibration body vibrates, and
a monitor electrode that outputs a monitor signal according to vibration of the vibration body;
a drive circuit that inputs the drive signal to the drive electrode of the angular-velocity detection element based on the monitor signal;
a sense circuit that outputs, based on the sense signal, an angular velocity signal indicating the angular velocity;
an acceleration detection element that outputs a signal according to acceleration applied to the acceleration detection element;
an acceleration detection circuit that outputs, based on the signal output from the acceleration detection element, an acceleration signal indicating the acceleration;
a first bandpass filter to which the acceleration signal is input;
a first amplitude determination circuit that determines, based on an amplitude of a first signal output from the first bandpass filter, whether or not the angular velocity signal is invalid; and
a timing control circuit that outputs a sensor output signal including the angular velocity signal and the acceleration signal.

2. The composite sensor according to claim 1, wherein the first amplitude determination circuit is configured to:
determine that the angular velocity signal is invalid when the amplitude of the first signal is more than or equal to a predetermined threshold; and
determine that the angular velocity signal is not invalid when the amplitude of the first signal is smaller than the predetermined threshold.

3. The composite sensor according to claim 1,
wherein the drive electrode receives the drive signal to cause the vibration body to vibrate at a drive frequency,
wherein the vibration body has configured to resonate at a detection frequency different from the drive frequency,
wherein the first bandpass filter passes substantially only a component of the acceleration signal with a first predetermined passing frequency, and outputs the component as the first signal, and
wherein the first predetermined passing frequency of the first bandpass filter is a detuning frequency that is a difference between the drive frequency and the detection frequency.

4. The composite sensor according to claim 3, further comprising:
a second bandpass filter to which the acceleration signal is input; and
a second amplitude determination circuit that determines, based on an amplitude of a second signal output from the second bandpass filter, whether or the angular velocity signal is invalid,
wherein the second bandpass filter passes substantially only a component of the acceleration signal with a second passing frequency different from the first predetermined passing frequency of the acceleration signal, and outputs the component with the second passing frequency as the second signal.

5. The composite sensor according to claim 1,
wherein the drive electrode receives the drive signal to cause the vibration body to vibrate at a drive frequency,
wherein the vibration body is configured to resonate at a detection frequency different from the drive frequency,
wherein the first bandpass filter passes substantially only a component of the acceleration signal with a first predetermined passing frequency of the acceleration signal, and outputs the component with the first predetermined passing frequency as the first signal,
wherein the first predetermined passing frequency of the first bandpass filter is the detection frequency or the drive frequency.

6. The composite sensor according to claim 5, further comprising:
a second bandpass filter to which the acceleration signal is input; and
a second amplitude determination circuit that determines, based on an amplitude of a second signal output from the second bandpass filter, whether the angular velocity signal is invalid or not,
wherein the second bandpass filter passes substantially only a component with a second passing frequency different from the first predetermined passing frequency of the acceleration signal, and outputs the component with the second passing frequency as the second signal.

7. The composite sensor according to claim 1,
wherein, when the first amplitude determination circuit determines that the angular velocity signal is invalid, the timing control circuit holds a value of the angular velocity signal immediately before the first amplitude determination circuit determines that the angular velocity signal is invalid, and
wherein the sensor output signal includes the held value of the angular velocity signal.

8. The composite sensor according to claim 1, wherein the sensor output signal further includes a self-diagnostic signal indicating whether the angular velocity signal is invalid or not.
